(19) United States
(12) Patent Application Publication
(10) Pub. No.: US 2015/0094124 A1
(43) Pub. Date: Apr. 2, 2015

(54) MOBILE TELEPHONE

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 14/092,944

(22) Filed: Nov. 28, 2013

(30) Foreign Application Priority Data
Sep. 30, 2013 (TW) 102135283

(51) Int. Cl. H04M 1/02

(52) U.S. Cl. CPC H04M 1/026
USPC 455/575.1

(57) ABSTRACT

The present disclose relates to a mobile telephone, including a main body, a light source and an optical element. The main body defines a cavity. The light source is received in the cavity. The optical element is removably mounted on the main body and located at a pathway of the light source. Light emitted from the light source is converged by the optical element to outside.

### BACKGROUND

1. Technical Field

The disclosure relates to electronic device, and particularly to a mobile telephone.

2. Description of Related Art

Generally, a mobile telephone includes a photoflash lamp for supplementing light when taking photography. A lens, such as a Fresnel lens is located at the light pathway of the photoflash lamp for diverging light. However, the light diverged angle of the photoflash lamp of the mobile telephone is too large to use as a flashlight.

Therefore, what is needed is a mobile telephone which can overcome the described limitations.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present mobile telephone. Moreover, in the drawing, like reference numerals designate corresponding parts throughout the whole view.

FIG. 1 is a schematic, isometric view of a mobile telephone according to an exemplary embodiment.

FIG. 2 is another schematic, isometric view of the mobile telephone of FIG. 1.

FIG. 3 is a cross-sectional view of the mobile telephone of FIG. 1, taken along line III-III thereof.

### DETAILED DESCRIPTION OF EMBODIMENTS

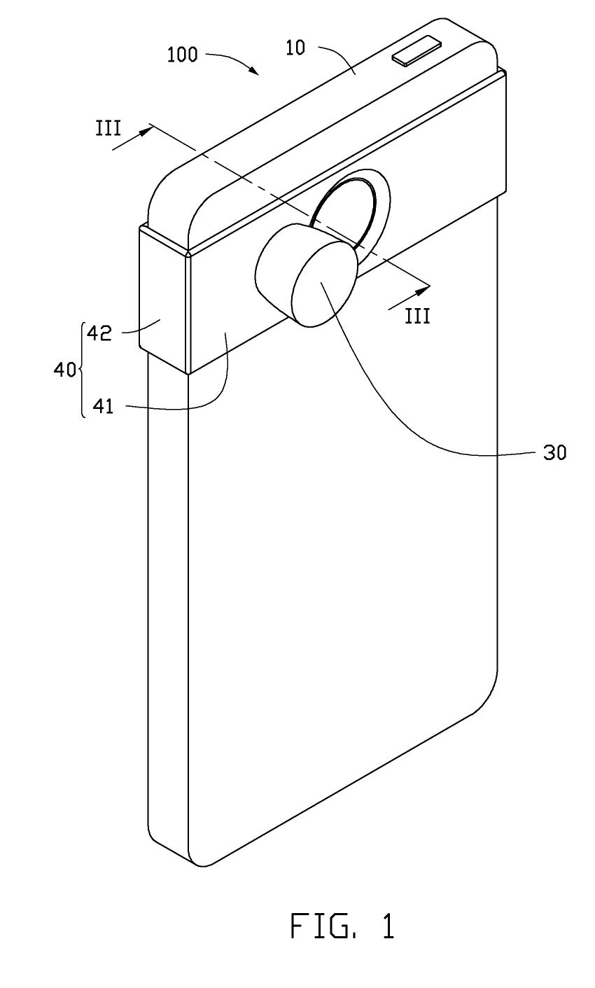

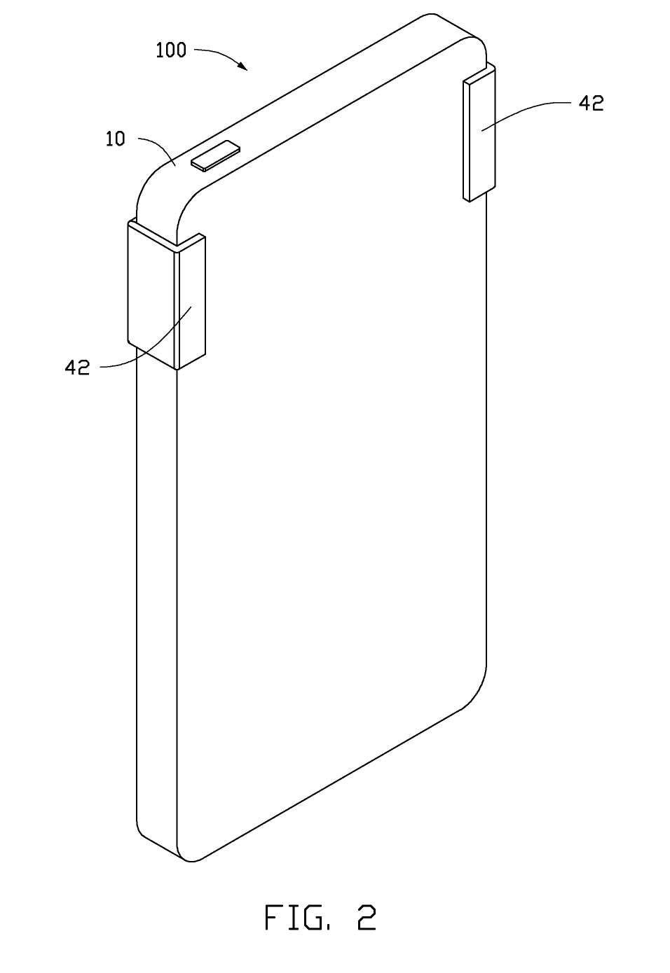

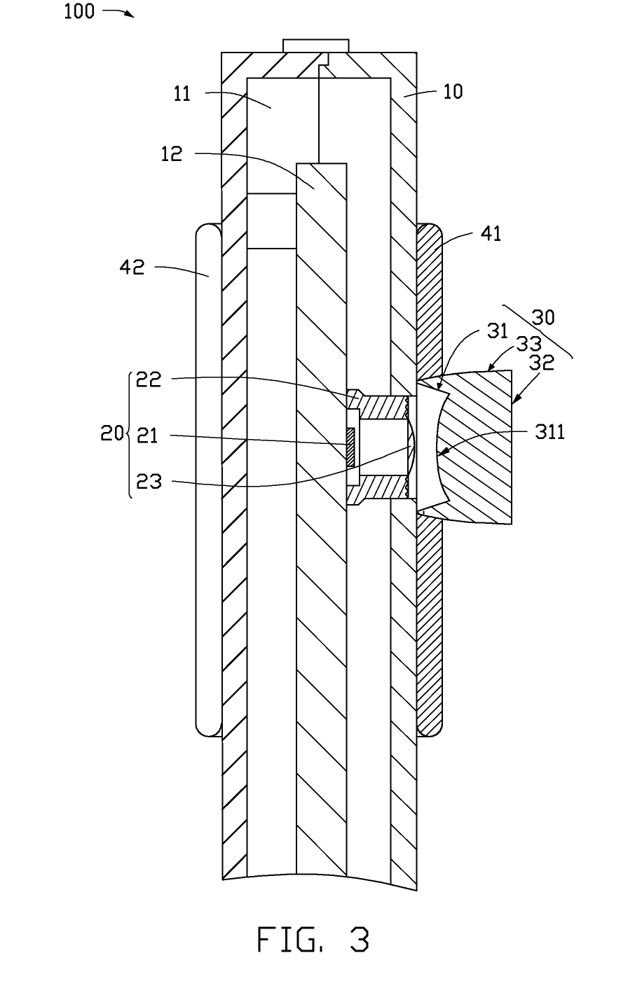

Referring to the FIGS. 1-3, a mobile telephone 100 in accordance with an exemplary embodiment of the present disclosure is shown. The mobile telephone 100 includes a main body 10, a light source 20, an optical element 30 and a fixing element 40.

In the present embodiment, the main body 10 defines a cavity 11 for receiving a circuit body 12. The light source 20 is received in the cavity 11 and arranged on the circuit body 12. The light source 20 includes light emitting element 21, a supporting element 22 surrounding the light emitting element 21 and a lens 23 arranged on the supporting element 22 and located at the light pathway of the light emitting element 21. In the present embodiment, the light emitting element 21 is an LED (light emitting diode) and arranged on the circuit body 12. The lens 23 is a convex lens. A top portion of the supporting element 22 includes a plurality of annular protrusions. The lens 23 and the annular protrusions cooperatively form a Fresnel lens for diverging light emitted from the light emitting element 21.

The optical element 30 includes a light input surface 31, a light output surface 32 opposite to the light input surface 31, and a side surface 33 positioned between and connected to the light input surface 31 and the light output surface 32. The light input surface 31 includes a convex surface 311 facing the lens 23 and protruding towards the light emitting element 21. The light output surface 32 is a planar surface, and the side surface 33 is a frusto-conical surface. The side surface 33 is a total reflective face. In the present embodiment, a central axis of the light emitting element 21 is coaxial to that of the optical element 30. Light beams emitted from the light source 20 pass through the light input surface 31 and enter the optical element 30. A part of light beams travels through the optical element 30 to an outside through the light output surface 32 directly, and the other part of light beams is reflected by the side surface 33 and then travels through the light output surface 32 of the optical element 30 to the outside. All light beams travelling through the optical element 30 are collimated and converged by the optical element 30. In the present embodiment, the optical element 30 is a collimating lens, and light beams travelling through the optical element 30 are collimated to parallel light beams.

The optical element 30 is extractably mounted on an outside of the main body 10 via the fixing element 40. In the present embodiment, the fixing element 40 includes a fixing part 41 and two clip parts 42 located at two ends of the fixing part 41. The optical element 30 is fixed on the fixing part 41, and the two clip parts 42 are respectively clasped with two edges of the main body 10. In the present embodiment, the fixing part 41 and the two clip parts 42 are integrally formed with one piece. The two clip parts 42 have elasticity; therefore, the fixing element 40 is fixed on the main body 10 steady by the elastic force generated therefrom.

When the light source 20 of the mobile telephone 100 is at a first state, functioning as flashlight. The optical element 30 is fixed on the main body 10 via the fixing element 40. Light emitted from the light source 20 is collimated and converged by the optical element 30; therefore, it can improve the brightness and the irradiate distance. When the light source 20 of the mobile telephone 100 is at a second state, functioning as photoflash, the optical element 30 is removed.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A mobile telephone, comprising:
a main body defining a cavity;
a light source received in the cavity; and
an optical element removably mounted on the main body and located at a pathway of the light source, light emitted from the light source being converged by the optical element to outside.

2. The mobile telephone of claim 1, wherein the optical element is a collimating lens.

3. The mobile telephone of claim 1, wherein the optical element comprises a light input surface, a light output surface opposite to the light input surface, and a side surface positioned between and connected to the light input surface and the light output surface, the light input surface comprising a convex surface facing the light source and protruding towards the light source, the light output surface being a planar surface, and the side surface being a total reflective face.

4. The mobile telephone of claim 1, wherein a central axis of the light source is coaxial to that of the optical element.

5. The mobile telephone of claim 1, further comprising a fixing element, the optical element being removably mounted on the main body via the fixing element.

6. The mobile telephone of claim 5, wherein the fixing element comprises a fixing part and two clip parts located at two ends of the fixing part, the optical element being fixed on the fixing part, and the two clip parts being respectively clasped with two edges of the main body.

7. The mobile telephone of claim 6, wherein the fixing part and the two clip parts are integrally formed with one piece.

8. The mobile telephone of claim 6, wherein the two clip parts are elastic.

9. A mobile telephone, comprising:
a main body defining a cavity;
a light source received in the cavity;
a fixing element removably mounted on the main body; and
a collimating lens fixed on the fixing element and located at a pathway of the light source via the fixing element, light emitted from the light source being converged by the optical element to outside.

10. The mobile telephone of claim 9, wherein the optical element comprises a light input surface, a light output surface opposite to the light input surface, and a side surface positioned between and connected to the light input surface and the light output surface, the light input surface comprising a convex surface facing the light source and protruding towards the light source, the light output surface being a planar surface, and the side surface being a total reflective face.

11. The mobile telephone of claim 9, wherein the fixing element comprises a fixing part and two clip parts located at two ends of the fixing part, the optical element being fixed on the fixing part, and the two clip parts being respectively clasped with two edges of the main body.
